(19) United States
(12) Patent Application Publication
(10) Pub. No.: US 2025/0371353 A1
(43) Pub. Date: Dec. 4, 2025

(54) METHOD AND SYSTEM FOR COST-OPTIMIZED TRAINING OF MACHINE LEARNING SYSTEMS

(71) Applicant: PRE INC., Toronto (CA)

(72) Inventors: PARHAM AARABI, Toronto (CA); YIQIAN QIN, Toronto (CA)

(21) Appl. No.: 18/677,794

(22) Filed: May 29, 2024

(51) Int. Cl. G06N 3/084

(52) U.S. Cl. CPC G06N 3/084

(57) ABSTRACT

Methods, systems and computer program products for training a network model (e.g. without limitation, a user transition probability model to mimic user interactions with a website) use a cost-optimized gradient descent (COGD) according to an embodiment. A method trains a model iteratively using COGD where, responsive to successive iterations of the training, parameters of the gradient descent are adjusted in a cost-optimized manner to sequentially increase data precision. Parameters of the gradient descent comprise may a cost parameter, a gradient range parameter and a learning rate parameter. By example, the cost is increased while either: gradient range is reduced; or gradient range and learning rate are reduced. In an embedment, goal-oriented training of the model is performed for each of a plurality of respective training goals, and training using cost-optimized gradient descent is performed in-turn (e.g. and in an order) for each respective training goal.

### FIELD OF INVENTION

This application relates to improvements to computers and machine learning, and more particularly to a method and system for cost-optimized training of machine learning systems.

### BACKGROUND

Gradient descent is a very basic method utilized in many machine learning systems. The underlying idea is to use the multi-dimensional error gradient as a directional cue for finding a local error minimum. While gradient descent can function efficiently even in the presence of a small amount of noise, prior methods have not explored the case where there is a tradeoff between the cost of a measurement (based on which the gradient is calculated) and the error of that measurement.

### SUMMARY

Methods, systems and computer program products for training a network model (e.g. without limitation, a user transition probability model to mimic user interactions with a website) use a cost-optimized gradient descent (COGD) according to an embodiment. A method trains a model iteratively using COGD where, responsive to successive iterations of the training, parameters of the gradient descent are adjusted in a cost-optimized manner to sequentially increase data precision. Parameters of the gradient descent comprise may a cost parameter, a gradient range parameter and a learning rate parameter. By example, the cost is increased while either: gradient range is reduced; or gradient range and learning rate are reduced. In an embedment, goal-oriented training of the model is performed for each of a plurality of respective training goals, and training using cost-optimized gradient descent is performed in-turn (e.g. and in an order) for each respective training goal.

There is provided a method for training a network model comprising: training a network model iteratively using cost-optimized gradient descent, wherein, responsive to successive iterations of the training, parameters of the gradient descent are adjusted in a cost-optimized manner to sequentially increase data precision.

In an embodiment of the method, parameters of the gradient descent comprise a cost parameter, a gradient range parameter and a learning rate parameter; and the cost parameter is increased while either: a gradient range parameter is reduced; or the gradient range parameter and a learning rate parameter are reduced. In an embodiment, the cost parameter is adjusted in a linear manner responsive to the successive iterations. In an embodiment, the gradient range parameter is adjusted in an exponential decay manner responsive to successive iterations. In an embodiment, the gradient range parameter is adjusted in a first exponential decay manner and the learning rate parameter is adjusted in a second exponential decay manner responsive to successive iterations.

In an embodiment, the method comprises performing goal-oriented training of the model for each of a plurality of respective training goals, and wherein the step of training the network model iteratively using cost-optimized gradient descent is performed in-turn for each respective training goal. In an embodiment, performing the goal-oriented training trains each respective training goal one by one to completion and in accordance with an ordering of the plurality of respective training goals.

In an embodiment, the model is a user transition probability network model to model user interactions with an e-commerce website.

In an embodiment, the method may include generating training data for use to train the model using COGD.

Corresponding system and computer program product aspects are also provided. A system can comprise at least one processor and a storge device storing instructions that are executable by the at least one processor to cause the system to perform a method herein. A computer program product can comprise a non-transient storage medium storing instructions, which instructions are executable by at least one processor to cause a system to perform a method herein. A system may comprise a single computing device or multiple computing devices. A computing device may comprise a computer such as a server, a laptop, a desktop or other form factor computer. The system may comprise a database or other data store storing data for training the model using COGD.

### BRIEF DESCRIPTION OF THE DRAWINGS

FIG. 1 is simplified illustration of user transition probability network across a three-page e-commerce website, in accordance with an embodiment.

FIG. 2 is a screen shot of a dashboard interface showing graphically a successive cost-optimized gradient descent, in accordance with an embodiment herein.

FIG. 3 is a graph 300 showing a plot of error over iterations for cost-optimized gradient descent from two representative simulations in accordance with an embodiment herein.

FIG. 4 is a graph 400 of cost, gradient range and learning rate over iterations of cost-optimized gradient descent, in accordance with an embodiment.

FIG. 5 is a flowchart of operations of a method herein, in accordance with an embodiment.

### DETAILED DESCRIPTION

Virtual data (or simulated, generated, or synthetic data) is understood to mean information that is generated artificially rather than real data, which is information that is produced and obtained from actual events in the real-world. Virtual data is usually created using algorithms and is generated for training and/or testing/validating a model such as a machine learning model. Operations for virtual data generation are associated with a cost as is training with each instance of such data.

Gradient Descent is a fundamental algorithm that is at the heart of nearly all modern AI systems (e.g. chatGPT of OpenAI, etc.). But while it works well for real data, there is a dilemma associated with systems that generate virtual data, namely, do you generate a few high-precision virtual data points, or, do you generate many low-precision virtual data points? Or, equivalently, in cases where data points are generated based on simulations, there would be a dilemma about running a high-precision/high-cost simulation, or a low-precision/low-cost simulation. This dilemma arises in many virtual training data cases, including training self-driving cars, computer vision tasks, speech recognition, human behavior modeling, and much more. To optimally answer this question, there is disclosed, in one or more embodiments, a method and system configured to perform Cost Optimized Gradient-Descent. In an embodiment, Cost Optimized Gradient-Descent starts with a large number of low-precision virtual data points, and precisely trains a network by sequentially increasing data precision. This results in an optimal and efficient training method with wide applicability (especially in virtual data AI systems).

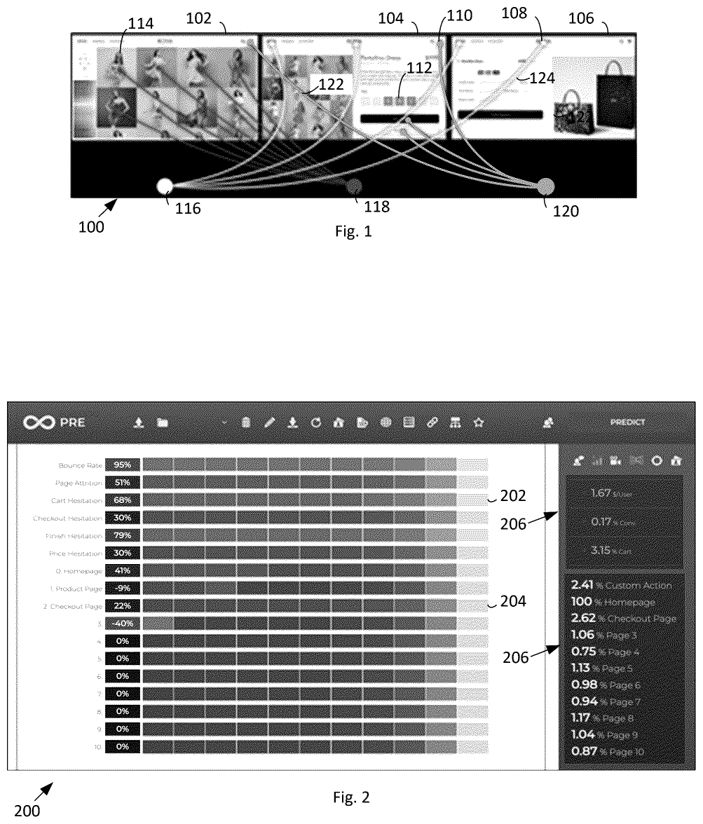

A motivation of this paper arises from a network simulation of human interactions on an e-commerce site. A goal is to create a user behavior model, such as that shown in FIG. 1, which is a simplified illustration of user transition probability network 100 across a three-page e-commerce website.

FIG. 1 shows three web pages 102, 104 and 106 of the e-commerce website, each of the pages 102, 104 and 106 having a plurality of controls (e.g. 108, 110, 112, and 114) (i.e. user interface (UI) elements). A control can be invoked through a gesture, keyboard input, etc. by a user's device (e.g. represented as 116, 118, 120) to provide input (e.g. represented as arcs between respective devices and controls (e.g. 122, 124)) to the website to perform an action such as for navigating the site, conducting a purchase, etc. Controls may be associated with UI content items such as product thumbnails, color swatches (e.g. as thumbnails), larger product images, icons, forms, menus, buttons, boxes, text (e.g. hyperlinked text), etc.

In an embodiment, the user transition probability network 100 mimics website interactions by actual human users. A transition probability matrix is denoted as T and a resulting site statistics vector as S(T). Every T will result in a corresponding S(T). In order to tune the model to specific web users, there is obtained actual site statistics S₀. In an embodiment, a goal is to find a T such that the error |S(T)−S₀| is minimized. For this, gradient descent (based training) is applied to find the T which minimizes the error.

In an embodiment of such a network, for the simulation of users, there is chosen a simulation size (i.e. actual number of virtual users simulated). A small number of simulated users will result in larger stochastic noise in S than a large number of users. However, a large number of users is computationally more expensive and requires more time and resources—there is a tradeoff between measurement cost and measurement accuracy, where the more accurate the measurement, the higher the cost.

As a result, there can be performed a noisy gradient descent with fewer simulated users at a lower cost or a more precise gradient descent with more simulated users at a higher cost. Neither option is ideal.

In accordance with an embodiment, there is provided a hybrid method comprising operations where the gradient descent is done more coarsely initially, at a lower cost and higher error, and as the weights converge (e.g. measured by reduction of error beyond a preset threshold) operations adaptively increase the cost thereby lowering the error. The underlying assumption here is that a coarse gradient descent is more noise resistant than a more fine-tuned one. Operations are outlined below:

For each element tᵢ in T, operations measure the error gradient

$${Δ}_{n} = \vert {S}_{n} ( {t}_{i} + δ ) - {S}_{0} \vert - \vert {S}_{n} ( {t}_{\dot{r}} δ ) - {S}_{0} \vert$$

where the index n corresponds to the number of simulated users. A higher n results in a higher cost.

Operations update that element with

$${t}_{i}^{+} = {t}_{i} - {αΔ}_{n} ,$$

where α is a learning rate (or gradient descent step size) and δ is the gradient range parameter.

Values of α and δ are fixed in a standard gradient descent operation (i.e. a current state of the art operation that is without the benefit of the teaching herein). In a present embodiment as taught herein, cost-optimized gradient descent operations start with a small n and large δ and α, and sequentially reduce both δ and α while increasing n. While the definition of small or large is context dependent, in one embodiment, the value of n, which corresponds to the number of simulated users (or alternatively, the number of simulation iterations on different users) (hence a cost value) was small in the 0-10,000 range and large in the >100,000 range, the value of δ would be small at approximately 0-5% of the total element value range and large in the >5% of the total element value range, and the value of a would be small at less than 0.1 and large at greater than 0.5.

FIG. 2 provides an illustration of a successive cost-optimized gradient descent in accordance with an embodiment herein and in which the embodiment comprises training a network to model user behavior with an ecommerce site. FIG. 2 illustrates the sequential results of this optimization in a dashboard 200, where each row (e.g. 202, 204) corresponds to a specific element, and successive columns to the left correspond to successive iterations of the gradient descent. Though FIG. 2 is presented in this application as a greyscale representation, color may be used. The darkness of the color (or shade) indicates the level of error (with lighter colors having a higher error than darker colors). In an embodiment, different colors can be used for positive and negative error representation.

FIG. 2 demonstrates how cost optimized gradient descent is used to optimize specific parameters of a user behavior model in the context of a virtual user simulation of an e-commerce site. Here, there are certain parameters such as page attrition, bounce rate, and hesitations related to specific pages of the site as well as hesitations related to adding a product to cart, price, checking out, and finalizing a purchase. These behavior parameters are to be tuned in the model such as through training. Cost optimized gradient descent is an effective method of tuning these parameters by adjusting them until the key metrics such as conversions and revenue per user match the actual statistics collected from a real-life website.

The icons at the top of the page in FIG. 2 represent user interface elements that allow for a virtual depiction of the e-commerce site to be build. These include options to add a page, move pages, label pages, and to navigate through different pages of the virtual site depiction.

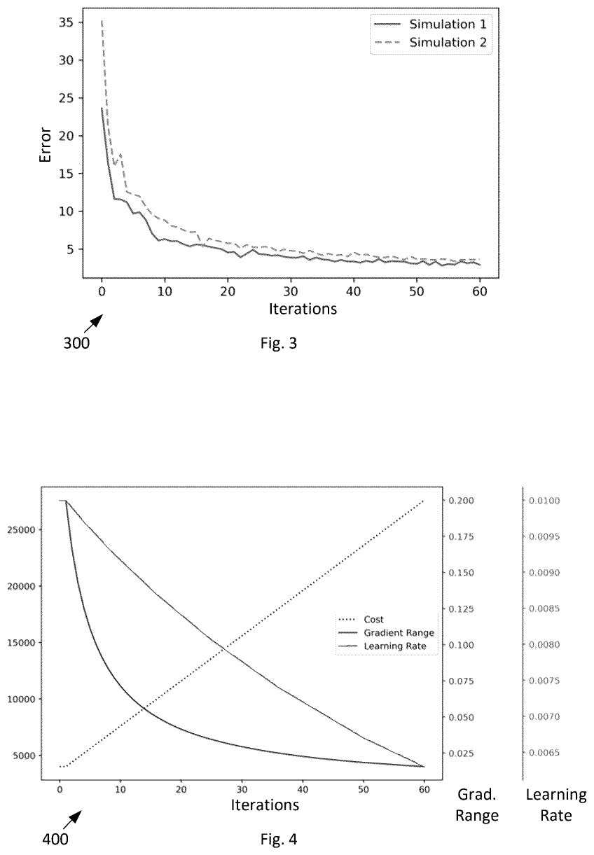

FIG. 3 is a graph 300 showing a plot of error over iterations for cost-optimized gradient descent from two representative simulations. Graph 300 visualizes the trend of measurement error over iterations of cost-optimized gradient descent. The initial error of simulation 2 is 35.2774, which is slightly higher than that of simulation 1. However, other parameters, including the cost, gradient range and learning rate of all the simulations are the same.

FIG. 4 is a graph 400 of cost, gradient range and learning rate over iterations of cost-optimized gradient descent. As is shown in FIG. 4, the initial cost, gradient range and learning rate are set at 4000, 0.2 and 0.01, respectively. By sequentially increasing the cost, while reducing the gradient range and the learning rate, the error of both simulations gradually decreases over successive iterations of the gradient descent. Though shown as continuous curves, for example, where gradient range and learning rate are similar to exponential decay functions, examples in practice may not be continuous or may approximate other functions. For example, stepwise changes can be made in practice that may be determined using a function. A value such as learning rate may be constant. Some parameter values may change each iteration while another parameter's value may change with a different period (e.g. every 5 iterations). For example, learning rate may have a first value for the first 50% of the iterations and a second value for the last 50%.

Table 1 shows quantitative results of 10 simulations including the initial T and error, as well as the minimum error after 60 successive iterations of the gradient descent. The initial error of each simulation varies greatly, ranging from 13.2605 to 122.7204. Nevertheless, after applying the cost-optimized gradient descent, the resulting minimum error remains relatively stable and lies below 3. The mean minimum error of all the simulations is 1.1721. Notably, among all the simulations, initial T=[0.2, 0.2, 0.3, 0.5, 0.7, 0.6] (with initial error=122.7204) achieves the best performance, resulting in a 99.2% reduction in error.

TABLE 1

| Initial T | Initial Error | Minimum Error |
|---|---|---|
| [0.7, 0.4, 0.1, 0.7, 0.4, 0.2] | 13.2605 | 0.6756 |
| [0.9, 0.2, 0.3, 0.7, 0.2, 0.2] | 13.9229 | 0.4471 |
| [0.2, 0.6, 0.2, 0.1, 0.6, 0.4] | 23.6231 | 2.7933 |
| [0.3, 0.2, 0.9, 0.2, 0.1, 0.2] | 111.7241 | 1.8525 |
| [0.8, 0.3, 0.2, 0.6, 0.2, 0.2] | 13.7441 | 0.3716 |
| [0.2, 0.5, 0.1, 0.4, 0.2, 0.7] | 25.8117 | 2.0637 |
| [0.2, 0.2, 0.3, 0.5, 0.7, 0.6] | 122.7204 | 0.9762 |
| [0.9, 0.1, 0.6, 0.5, 0.6, 0.6] | 39.7253 | 0.6378 |
| [0.5, 0.5, 0.2, 0.9, 0.1, 0.3] | 16.7209 | 0.9834 |
| [0.6, 0.4, 0.2, 0.9, 0.4, 0.9] | 15.7687 | 0.9188 |

The presented methodology is one class of a larger set of machine learning systems were a Goal-Oriented Training Agent optimizes the number of precision (e.g. a cost) of the training data to achieve specific goals. In the example outlined above, the goal is to achieve a high accuracy (or conversely, low error) rate while also minimizing cost. In an embodiment, for example, the goal could be to train a machine learning system with a baseline level of precision/error, and then to fine tune for specific performance criteria. The training in the embodiment is performed in a plurality of stages or steps, for example, two stages. In accordance with an embodiment, operations train a self-driving vehicle in two stages. The first stage trains in a medium-precision synthetic/virtual environment (e.g. a first precision environment having an associated first cost) to stay within the right lanes. Operations then fine-tune the model with further training in a second stage using high-precision synthetic data for accident avoidance (e.g. training in a second precision environment having an associated second cost). In the embodiment, the associated second cost is greater than the associated first cost.

Thus Goal-Oriented Training Agents can be used for one specific training stage and they can also be used for training when more than one stage or step is required. Consider the example of FIG. 2 where the goal is to train the parameters of a user behavior model for the purpose of simulating an e-commerce site. Here, as an example embodiment, a series of goals could be set that, for example, consist of 1) training key parameters such as page attrition and bounce rate, 2) training secondary parameters such as cart or checkout hesitations, 3) training all parameters with the goal of getting the lowest error specifically for conversions, and 4) training all parameters with the goal of minimizing error across all output statistics. Goal-Oriented Training allows for training to be performed in a key series of steps.

In the case of training a virtual shopper model, as one example, one could optionally train the user model to achieve similar traffic as actual user traffic on the site pages with a small virtual user population size (e.g. less than 50,000), and then fine-tune the model with a large virtual user population size (e.g. greater than 50,000) specifically for key statistics such as conversions and cart-rate. During this training, at each stage, the training parameters are sequentially adjusted using the cost optimized gradient descent approach. In this case, as an example, for the first stage the number of simulated users is expanded from a low initial number (e.g. 5,000) and increased to 50,000, and in the second stage, they start at the 50,000 mark and are increased to obtain better precision.

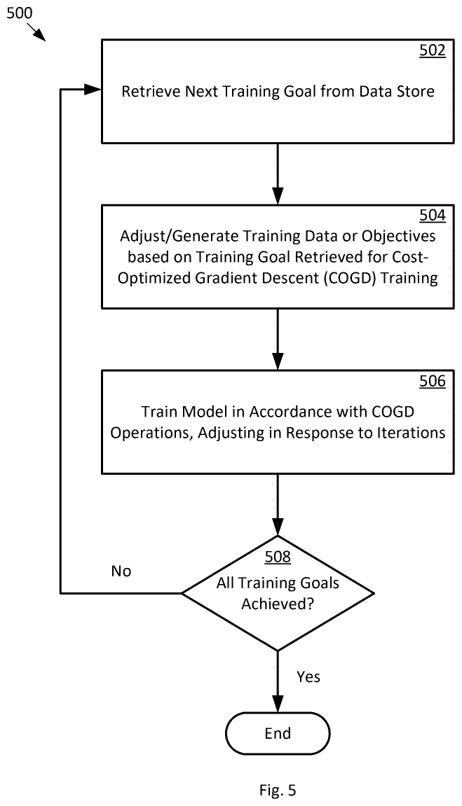

FIG. 5 shows a flow chart of operations 500, in an embodiment, for training a model using a goal-oriented training approach in one or more steps with respective cost-optimized gradient descent training. Though not shown in FIG. 5, a series of pre-defined training goals are stored in a database. The goals are stored in a sequential order or otherwise associated with an order for sequential retrieval. In an embodiment, each goal provides information for adjusting or generating training data or training objectives. In an embodiment, respective cost-optimized gradient descent parameters are associated with each goal, for example defining at least some of initial cost, gradient range and learning rate values so that, during training of the model, and responsive to iterations of the training, the cost-optimized gradient descent parameters are adjusted such as earlier described herein. Another element of Goal Oriented Training is the selection of which parameters to train on and which to ignore. Here, as may arise in many practical cases, training may involve multiple parameters and with Goal Oriented Training, a predefined set of parameters are trained at each stage.

At 502, operations retrieve a next training goal from a data store such as a database. At 504, operations adjust/generate training data or training objectives based on the next training goal retrieved for cost-optimized gradient descent (COGD) training of the model. At 506, operations train the model in accordance with the cost-optimized gradient descent parameters, adjusting values of at least some of them in response to iterations of the training. At 508, a check of goals is performed and a decision is made whether all goals are achieved. If no, via branch to 502, operations are repeated for a next training goal. If yes, goal-oriented training operations end.

Now let us see this in the context of an example for training a virtual human behavior model based on shopper data on an e-commerce site. In this example, consider the case where the training goals are to coarsely train the model to match the page traffic on a particular site, and to finely train the model to match the key statistics of the site such as conversions, add-to-cart rate, and revenue. Here, the training agent first retrieves the first goal of coarse training based on page traffic. Given this, it generates synthetic user data with a small (10,000) number of virtual users and subsequently trains the virtual user parameters using gradient descent to match the actual observed page traffic on the site. Once this is complete, the training agent retrieves the next goal of finely training the model based on key statistics. Here, the training agent increases the virtual population size (for example, to 200,000), and then does a more detailed/precise training of the system, again using gradient descent, to match the key statistics (conversions, cart-rate, and revenue). Once this is complete, the goals have been achieved and the training is then assumed to be complete.

In this paper we presented a gradient descent method that optimized the cost vs. accuracy tradeoff related to each gradient measurement. By sequentially reducing the learning rate and the gradient range, while increasing cost, we get a coarse measurement of the local minima at a low cost, and a more precise measurement at a higher cost but only after we are close to the local minima.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise. By way of example and without limitation, references to a computing device comprising a processor and/or a storage device includes a computing device having multiple processors and/or multiple storage devices. Herein, “A and/or B” means A or B or both A and B.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

It will be understood that corresponding computer implemented method aspects and/or computer program product aspects are also disclosed. A computer program product, for example, comprises a storage device storing computer readable instructions that when executed by at least one processor of a computing device causes the computing device to perform operations of a computer implemented method.

### REFERENCES

1. Amari, S. I., 1993. Backpropagation and stochastic gradient descent method. Neurocomputing, 5 (4-5), pp. 185-196
2. Zhou, X., 2018 April. Understanding the convolutional neural networks with gradient descent and backpropagation. In Journal of Physics: Conference Series (Vol. 1004, p. 012028). IOP Publishing.
3. Song, G., Xu, R. and Lafferty, J., 2021. Convergence and alignment of gradient descent with random backpropagation weights. Advances in Neural Information Processing Systems, 34, pp. 19888-19898.
4. Wu, J., Hu, W., Xiong, H., Huan, J., Braverman, V. and Zhu, Z., 2020 November. On the noisy gradient descent that generalizes as sgd. In International Conference on Machine Learning (pp. 10367-10376). PMLR.
5. Li, M., Soltanolkotabi, M. and Oymak, S., 2020 June. Gradient descent with early stopping is provably robust to label noise for overparameterized neural networks. In International conference on artificial intelligence and statistics (pp. 4313-4324). PMLR.

What is claimed is:

1. A method for training a network model comprising:
training a network model iteratively using cost-optimized gradient descent, wherein, responsive to successive iterations of the training, parameters of the gradient descent are adjusted in a cost-optimized manner to sequentially increase data precision.

2. The method of claim 1, wherein:
parameters of the gradient descent comprise a cost parameter, a gradient range parameter and a learning rate parameter; and
the cost parameter is increased while either:
a gradient range parameter is reduced; or
the gradient range parameter and a learning rate parameter are reduced.

3. The method of claim 2, wherein the cost parameter is adjusted in a linear manner responsive to the successive iterations.

4. The method of claim 2, wherein the gradient range parameter is adjusted in an exponential decay manner responsive to successive iterations.

5. The method of claim 4, wherein the gradient range parameter is adjusted in a first exponential decay manner and the learning rate parameter is adjusted in a second exponential decay manner responsive to successive iterations.

6. The method of claim 1, comprising performing goal-oriented training of the model for each of a plurality of respective training goals, and wherein the step of training the network model iteratively using cost-optimized gradient descent is performed in-turn for each respective training goal.

7. The method of claim 6, wherein performing the goal-oriented training trains each respective training goal one by one to completion and in accordance with an ordering of the plurality of respective training goals.

8. A system comprising at least one processor and a storge device storing instructions that are executable by the at least one processor to cause the system to:
train a network model iteratively using cost-optimized gradient descent, wherein, responsive to successive iterations of the training, parameters of the gradient descent are adjusted in a cost-optimized manner to sequentially increase data precision.

9. The system of claim 8, wherein:
parameters of the gradient descent comprise a cost parameter, a gradient range parameter and a learning rate parameter; and
the cost parameter is increased while either:
a gradient range parameter is reduced; or
the gradient range parameter and a learning rate parameter are reduced.

10. The system of claim 8, wherein the cost parameter is adjusted in a linear manner responsive to the successive iterations.

11. The system of claim 8, wherein the gradient range parameter is adjusted in an exponential decay manner responsive to successive iterations.

12. The system of claim 11, wherein the gradient range parameter is adjusted in a first exponential decay manner and the learning rate parameter is adjusted in a second exponential decay manner responsive to successive iterations.

13. The system of claim 8, wherein the instructions are executable by the processor to cause the system to perform goal-oriented training of the model for each of a plurality of respective training goals, and wherein to train the network model iteratively using cost-optimized gradient descent is performed in-turn for each respective training goal.

14. The system of claim 13, wherein the goal-oriented training trains each respective training goal one by one to completion and in accordance with an ordering of the plurality of respective training goals.

15. A computer program product comprising a non-transient storage medium storing instructions, which instructions are executable by at least one processor to cause a system to:
train a network model iteratively using cost-optimized gradient descent, wherein, responsive to successive iterations of the training, parameters of the gradient descent are adjusted in a cost-optimized manner to sequentially increase data precision.

16. The method of claim 1, wherein the model is a user transition probability network model to model user interactions with an e-commerce website.

17. The method of claim 6, wherein the model is a user transition probability network model to model user interactions with an e-commerce website.

18. The system of claim 8, wherein the model is a user transition probability network model to model user interactions with an e-commerce website.

19. The system of claim 13, wherein the model is a user transition probability network model to model user interactions with an e-commerce website.

20. The computer program product of claim 15, wherein the model is a user transition probability network model to model user interactions with an e-commerce website.
